(19) United States
(12) Patent Application Publication
(10) Pub. No.: US 2012/0057946 A1
(43) Pub. Date: Mar. 8, 2012

(54) HOLDING APPARATUS FOR CUTTING TOOL

(75) Inventor: Haruaki KUBO, Nara-shi (JP)

(73) Assignee: Daishowa Seiki Kabushiki Kaisha d/b/a BIG DAISHOWA SEIKI CO LTD, Osaka (JP)

(21) Appl. No.: 13/226,622

(22) Filed: Sep. 7, 2011

(30) Foreign Application Priority Data
Sep. 8, 2010 (JP) 2010-201268

(51) Int. Cl. B23C 5/26

(52) U.S. Cl. 409/234

(57) ABSTRACT

In order to prevent a cutting tool from being detached from the holding device towards a bladed part-side when holding a standard cutting tool in the holding apparatus, a focus was placed on a diameter of a shank of the standard cutting tool which is larger than that of a bladed part-side cylindrical portion. A pressing portion pushes a retaining ring along a slope in a tool inserting hole towards its base end side so that an outer periphery of the retaining ring shrinks and an inner diameter of the retaining ring becomes smaller than the diameter of the shank.

### BACKGROUND

1. Field of the Invention

The present invention relates to an apparatus for holding a cutting tool, and more particularly, to a holding apparatus for a cutting tool such as endmill which is disposed in an inserting hole of a tool holder.

2. Description of the Related Art

A tool holder is attached to a spindle of a machine tool, with a tool such as a cutting tool held in an inserting hole of the tool holder. A shank of the cutting tool, which is to be inserted in the tool holder, is generally made in a cylindrical shape. Examples of the tool holder for holding the cylindrical shank include collet chuck and hydraulic chuck whose inner diameter can be reduced through elastic deformation by inward pressure or distributed load from an outer periphery of the chuck. The elastic deformation on the inner diameter of a holding portion of the tool holder generates a pressure which serves as a frictional force to hold the shank of the cutting tool. When a cutting force which is caused by working is larger than a holding force by the tool holder acts on the cutting tool in a direction in which the cutting tool is detached from the tool holder, the cutting tool moves outwardly in the direction in which the cutting tool is detached, from the initial position where it was originally attached. Cutting in this condition can cause interference against a workpiece and it may be excessively cut than designated, which hinders accurate working to obtain a workpiece according to a specification.

In order to solve this problem, there has been proposed a method for increasing the holding force of the tool holder, which however resulted in facing a limit of the holding force in the cylindrical shank since the holding force is exerted by the frictional force. Accordingly, there has been also proposed a method in which grooves or cuts are provided in the shank of the cutting tool, and an engaging part is provided on the tool holder to thereby fix the position of the cutting tool (see, for example, Japanese Unexamined Patent Application Publication Translation of PCT Application No. 2009-532220, and Japanese Unexamined Patent Application Publication No. 2006-247764).

According to the former patent document, with respect to attachment of an article to a chuck, a ridge is provided on one of the article and the chuck to be engaged with a groove provided on the other of them in order to avoid slips in an axial direction between the article and the chuck. Specifically, a tool holder and a cutting tool are firmly fixed by engaging together the groove on the cutting tool and the ridge on the chuck (tool holder). However, this configuration requires the cutting tool with a standard cylindrical shank to be provided with the groove, thus the cutting tool needs to be particularly fabricated as such.

According to the latter patent document, when a sealing nut engaged with the tool holder is tightened, a protrusion formed in an inner periphery of the sealing nut pushes a slidable member installed in the tool holder toward a base end side. This slidable member in turn presses and deforms an annular elastic member. Generally, in the standard cutting tool with a cylindrical shank such as endmill, a diameter of the shank is larger than a diameter of a portion extending from its bladed part to the shank. Therefore a step is formed between different outer diameters on the outer surface of the cutting tool to be held. The elastic member is pressed against the step and an outer periphery of the portion with the smaller diameter. This allows the cutting tool to be fixed in a state in which the cutting tool is prevented from slipping in axial and rotational directions. However, the cutting tool cannot be fixed in such a manner that slipping of the cutting tool in the axial direction is completely suppressed, due to elastic deformation of the elastic member itself.

Accordingly, it is desired to provide a holding apparatus for a cutting tool in which a cutting tool having a standard cylindrical shank can be used, and the position of the cutting tool can be determined at which the cutting tool is prevented from being detached in the axial direction from the tool holder.

### SUMMARY OF THE INVENTION

In one aspect of the present invention, there is provided an apparatus for holding a cutting tool, the cutting tool including: a blade-side cylindrical portion; a cylindrical shank having a larger diameter than that of the blade-side cylindrical portion; and a wall forming a step between the shank and the blade-side cylindrical portion, which apparatus includes a cylindrical tool inserting hole for receiving the cutting tool shank and configuration to determine a position of the cutting tool at which the cutting tool is prevented from being detached in an axial direction from the apparatus, the apparatus further including: a retaining ring with a larger inner diameter than the diameter of the shank when no external force is applied to the retaining ring; a holding body including: the tool inserting hole; a cavity on a side of an opening of the tool inserting hole, in which cavity the retaining ring is seated whose inner diameter is smaller than the diameter of the shank; and a slope which gradually increases a diameter of the tool inserting hole from the cavity towards the opening; and a pressing member which is disposed onto an inner diameter bigger than the blade-side cylindrical portion and a pressing portion for pushing the retaining ring from the opening into the cavity, wherein when the pressing member moves in a direction from the opening side to a cavity side, the pressing portion pushes the retaining ring along the slope in the cavity from a larger diameter side to a smaller diameter side so that an outer periphery of said retaining ring shrinks and an inner diameter of the retaining ring becomes smaller than the diameter of the shank.

In the present invention, the elastic retaining ring radially shrinks and expands relative to a standard cutting tool having the wall between the bladed part and the shank having a larger diameter than the bladed part. Therefore, the cutting tool can be easily inserted in the tool holding body under the condition that the inner diameter of the retaining ring is larger than that of the shank. On the other hand, when the retaining ring shrinks to fix the cutting tool in the holding apparatus, the inner diameter of the retaining ring becomes smaller than that of the tool inserting hole. Here, the retaining ring comes into contact with the wall of the cutting tool to prevent the cutting tool from being detached from the holding apparatus. With the configuration of the present invention, an effect of preventing detachment can be exerted even for standard cutting tools, and it requires neither special fabrication nor production of special cutting tools.

### BRIEF DESCRIPTION OF THE DRAWINGS

FIG. 1 is a cross sectional side view of a holding apparatus of the present invention with a chuck that holds a cutting tool.

FIG. 2 is a cross sectional side view showing a state in which a pressing member is away from a tool holding body.

FIG. 3 is a cross sectional side view showing a state in which the pressing member has moved axially from an inserting hole of the tool holding body towards a cavity.

### DETAILED DESCRIPTION OF THE PREFERRED EMBODIMENTS

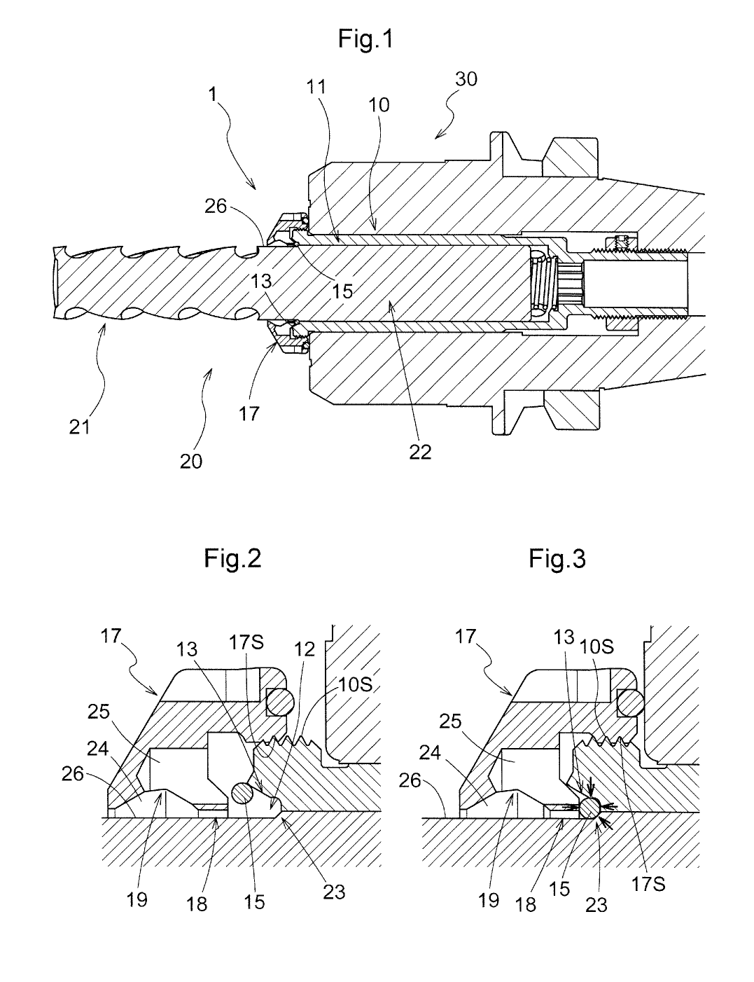

FIG. 1 shows a cross sectional side view in which a tool holding apparatus 1 of the present invention holds a cutting tool 20 in radial and axial directions, and a tool holder 30 together with the tool holding apparatus 1 holds the cutting tool 20. The tool holding apparatus 1 is fixed axially by threads to a bottom of a holding part of the tool holder 30. FIG. 2 is a cross sectional side view showing a state in which a pressing member 17 of the tool holding apparatus 1 is away from a holding body 10, and an outer diameter of a retaining ring 15 is enlarged (increased). FIG. 3 is a cross sectional side view showing a state in which the pressing member 17 of the tool holding apparatus 1 comes closer to the holding body 10 while shrinking (decreasing) the diameter of the retaining ring 15 and moving the retaining ring 15 into a cavity 12 to hold the retaining ring 15 in the radial and axial (detaching) directions.

The tool cutting apparatus 1 as a minimum configuration includes: the retaining ring 15 which has at least enough material strength to receive a force of the cutting tool 20 exerted in the axial direction during cutting works; the holding body 10 with a tool inserting hole 11 for receiving a shank 22 of the cutting tool 20; and the pressing member 17 for shrinking and enlarging the retaining ring 15.

The cutting tool 20 with the standard cylindrical shank 22 such as endmill has a bladed part-side cylindrical portion 26 with a smaller outer diameter than that of the shank 22 at a position between the shank 22 and bladed part 21, and a wall 23 which compensates a step as the difference in the outer diameters. The retaining ring 15 is in a shape of an annular ring whose cross section may be circle, square, rectangle, or trapezoid so as to be received on the wall 23. An inner diameter of the ring is set so that the shank 22 can be inserted thereinto, and shrinks smaller than at least the diameter of the shank 22 when it receives forces from an outer periphery of the ring. Also, the retaining ring 15 is required to be provided with enough material strength and cross-sectional areas to receive an axial force towards a position at which the cutting tool 20 is detached from the tool holding apparatus 1 during cutting works of the cutting tool 20.

The holding body 10 is provided with the cylindrical tool inserting hole 11 where the cutting tool 20 with the cylindrical shank 22 is disposed. In the tool inserting hole 11, on a side from which the cutting tool 20 is inserted, the cavity 12 is provided in which the retaining ring 15 can be seated when the inner diameter of the retaining ring 15 shrinks (decreases) smaller than the diameter of the shank 22 of the cutting tool 20. Also, a slope 13 is provided which gradually increases a diameter of the tool inserting hole 11 from the cavity 12 towards the opening of the tool inserting hole 11.

The pressing member 17 includes: an inner diameter which is at least larger than the diameter of the bladed part-side cylindrical portion 26 of the cutting tool 20 and the diameter of the shank 22; and a pressing portion 18 for pushing the retaining ring 15 along the slope 13 at the opening of the tool inserting hole 11 to the cavity 12. When the retaining ring 15 does not receive any external force, the inner diameter of the retaining ring 15 is larger than that of the shank 22 of the cutting tool 20.

On the holding body 10, an external thread 10S is formed in an outer periphery around the opening of the tool inserting hole 11. Also, on a pressing portion-side of the pressing member 17, there is formed an internal thread 17S having a larger diameter than the pressing portion 18. By screwing and loosening these external and internal threads, a distance between the pressing member 17 and the holding body 10 becomes shorter and longer, respectively.

The retaining ring 15 is placed between the slope 13 of the holding body 10 and the pressing portion 18 of the pressing member 17. The slope 13 and the pressing portion 18 come nearer as the threads are engaged between the pressing member 17 and the holding body 10. The pressing portion 18 pushes the retaining ring 15 to bring the retaining ring 15 into contact with the slope 13, shrinks the outer diameter of the retaining ring 15, which in turn makes the inner diameter of the retaining ring 15 smaller than the outer diameter of the shank 22 of the cutting tool 20. This brings the retaining ring 15 into contact with the wall 23 of the cutting tool 20, and the cutting tool 20 is prevented from being detached.

For attaching the cutting tool 20, the position of the retaining ring 15 is determined by the engagement of the pressing member 17 and the holding body 10 so that the inner diameter of the retaining ring 15 is set larger than the outer diameter of the shank 22 of the cutting tool 20. The shank 22 of the cutting tool 20 is inserted through the pressing member 17 and the retaining ring 15 into the tool inserting hole 11 of the holding body 10 until the wall 23 of the cutting tool 20 passes the retaining ring 15. Here, the retaining ring 15 may have a smaller inner diameter than the outer diameter of the shank 22 when no external pressure is applied to the retaining ring 15, as long as the shank 22 can be inserted into the retaining ring 15 whose inner diameter is increased due to elasticity of the retaining ring 15 by the insertion of the shank 22. In the initial step, it should be noted that the position at which the pressing member 17 is engaged should allow the inner diameter of the retaining ring 15 to become larger than the outer diameter of the shank 22. Also, even if the inner diameter of the retaining ring 15 is smaller than that of the outer diameter of the shank 22, when the retaining ring 15 has a circular cross-section and the diameter of a centerline of the circular cross-section is larger than the outer diameter of the top of the shank 22, the inner diameter can be elastically enlarged.

By screwing up the pressing member 17 and the holding body 10 to the position where the inner diameter of the retaining ring 15 becomes smaller than the diameter of the shank 22 of the cutting tool 20, and by pulling the cutting tool 20 towards the detaching direction, the wall 23 and the retaining ring 15 abut each other and stop.

As in FIG. 1, when the holding body 10 is a collet whose outer periphery is in a shape of a cylinder and is configured to be held by the tool holder 30, the outer periphery of the holding body 10 elastically deforms and the cutting tool 20 can be held by the inner periphery. Alternatively, the holding body 10 can also be provided directly in the tool holder 30.

It is also possible that a slit for facilitating elastic deformation is provided on the holding body 10, as a passage through which a fluid flows from the tool holder 30, together with a flow channel 19 provided in the pressing member 17 as a passage from a pressing portion 18-side to a bladed portion 26-side, to thereby supply oil to the cutting tool 20. More specifically, as shown in FIG. 2, after a groove 24 is formed along the inner periphery of the pressing member 17, a drilled hole 25 is formed from the cavity 12 of the pressing member 17 towards the groove 24. The several drilled holes 25 are provided circumferentially on the pressing member 17. With this configuration, the drilled holes 25 and the groove 24 communicate with each other to form the flow channel 19.

The present invention is applicable to an apparatus for holding a cutting tool such as endmill.

What is claimed is:

1. An apparatus for holding a cutting tool,
the cutting tool comprising: a blade-side cylindrical portion; a cylindrical shank having a larger diameter than that of the blade-side cylindrical portion; and a wall forming a step between the shank and the blade-side cylindrical portion,
the apparatus comprising a cylindrical tool inserting hole for receiving the cutting tool shank and a configuration to determine a position of the cutting tool at which the cutting tool is prevented from being detached in an axial direction from the apparatus,
the apparatus further comprising:
a retaining ring with a larger inner diameter than the diameter of the shank when no external force is applied to the retaining ring;
a holding body comprising: the tool inserting hole; a cavity on a side of an opening of the tool inserting hole, in which cavity the retaining ring is seated whose inner diameter is smaller than the diameter of the shank; and a slope which gradually increases a diameter of the tool inserting hole from the cavity towards the opening; and
a pressing member which is disposed onto the blade-side cylindrical portion and includes a pressing portion for pushing the retaining ring from the opening into the cavity,
wherein when the pressing member moves in a direction from an opening side to a cavity side, the pressing portion pushes the retaining ring along the slope into the cavity from a larger diameter side to a smaller diameter side so that an outer periphery of the retaining ring shrinks and an inner diameter of the retaining ring becomes smaller than the diameter of the shank.

2. The apparatus according to claim 1, wherein the retaining ring has a circular cross section.

3. The apparatus according to claim 1, wherein the pressing member has a flow channel for allowing a fluid to flow from the pressing portion to the bladed part-side cylindrical portion.

4. The apparatus according to claim 1, wherein the holding body is a collet having a cylindrical outer periphery, is held in the tool holder and fixed in an axial direction by an engaging portion.
